(19) United States
(12) Patent Application Publication
(10) Pub. No.: US 2023/0066845 A1
(43) Pub. Date: Mar. 2, 2023

(54) PREDICTING AND MANAGING A COLLABORATION DELAY

(71) Applicant: International Business Machines Corporation, Armonk, NY (US)

(72) Inventors: Raghuveer Prasad Nagar, Kota (IN); Siddharth R. Rao, Bangalore (IN); Jagadesh Ramaswamy Hulugundi, Bangalore (IN); Sowjanya Tummala, Bangalore (IN)

(21) Appl. No.: 17/412,853

(22) Filed: Aug. 26, 2021

(51) Int. Cl. G06Q 10/10

(52) U.S. Cl. CPC G06Q 10/1095; G06Q 10/103; G06Q 10/101

(57) ABSTRACT

In an approach to predicting and managing a collaboration delay, one or more computer processors detect a start of a first collaborative meeting. One or more computer processors identify one or more attendees of the first collaborative meeting. One or more computer processors determine a status of one or more missing participants. Based on the status, one or more computer processors predict a delay duration and a reason for a delay of at least one of the one or more missing participants. Based on the prediction, one or more computer processors determine a first reschedule recommendation for the first collaborative meeting. One or more computer processors present the first reschedule recommendation to the one or more attendees. One or more computer processors reschedule the first collaborative meeting. One or more computer processors notify the one or more attendees of the first collaborative meeting of the reschedule.

### BACKGROUND OF THE INVENTION

The present invention relates generally to the field of Internet of Things, and more particularly to predicting and managing a collaboration delay.

The Internet of Things (IoT) is the internetworking of physical devices (also referred to as “connected devices” and “smart devices”), vehicles, buildings, and other items, embedded with electronics, software, sensors, actuators, and network connectivity that enable these objects to collect and exchange data. The IoT allows objects to be sensed and/or controlled remotely across existing network infrastructure, creating opportunities for more direct integration of the physical world into computer-based systems, and resulting in improved efficiency, accuracy, and economic benefit in addition to reduced human intervention. Each “thing” is uniquely identifiable through its embedded computing system but is able to interoperate within the existing Internet infrastructure.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results, and to uncover hidden insights through learning from historical relationships and trends in the data.

Web conferencing is used as an umbrella term for various types of online conferencing and collaborative services including webinars (“web seminars”), webcasts, and web meetings. Web conferencing applications offer data streams of text-based messages, voice, and video chat to be shared simultaneously across geographically dispersed locations. Applications for web conferencing include meetings, training events, lectures, or presentations from a web-connected computer to other web-connected computers. Depending on the technology being used, participants may speak and listen to audio over standard telephone lines or via computer microphones and speakers. Some products allow for use of a webcam to display participants, as well as screen sharing capability for display of content from a participant's computer.

### SUMMARY

Embodiments of the present invention disclose a computer-implemented method, a computer program product, and a system for predicting and managing a collaboration delay. The computer-implemented method may include one or more computer processors detecting a start of a first collaborative meeting. One or more computer processors identify one or more attendees of the first collaborative meeting. One or more computer processors determine a status of one or more missing participants. Based on the status, one or more computer processors predict a delay duration and a reason for a delay of at least one of the one or more missing participants. Based on the prediction, one or more computer processors determine a first reschedule recommendation for the first collaborative meeting. One or more computer processors present the first reschedule recommendation to the one or more attendees. One or more computer processors reschedule the first collaborative meeting. One or more computer processors notify the one or more attendees of the first collaborative meeting of the reschedule.

### BRIEF DESCRIPTION OF THE DRAWINGS

FIG. 1 is a functional block diagram illustrating a distributed data processing environment, in accordance with an embodiment of the present invention;

FIGS. 2A and 2B are a flowchart depicting operational steps of a collaboration delay program, on a server computer within the distributed data processing environment of FIG. 1, for managing a collaboration delay, in accordance with an embodiment of the present invention;

FIG. 3 is a flowchart depicting operational steps of the collaboration delay program, on the server computer within the distributed data processing environment of FIG. 1, for predicting a collaboration delay, in accordance with an embodiment of the present invention; and

FIG. 4 depicts a block diagram of components of the server computer executing the collaboration delay program within the distributed data processing environment of FIG. 1, in accordance with an embodiment of the present invention.

### DETAILED DESCRIPTION

Meetings may be considered one of the most important activities in a business environment. Many organizations hold regular meetings as part of their routine operations. Delivering information, keeping colleagues and customers updated, discussing issues around team projects, assigning tasks, tracking progress, and making decisions are some of the reasons that meetings are an important part of professional activity. Meetings may be held in a variety of manners, including, but not limited to, in person, via teleconference, or via web conference. When a host or a participant of a web conference is late to a meeting, it can cause inefficiencies and lost productivity. There is currently no way for the host or participant to communicate being late via the collaborative meeting platform being used for the meeting, and users may resort to using alternate modes of communication, such as phone, instant messaging, etc., to alert the other users.

Embodiments of the present invention recognize that efficiency may be gained by providing an enhancement to a collaborative meeting platform that can proactively communicate a duration and reason for a meeting participant's absence to the other participants. Embodiments of the present invention also recognize that efficiency may be gained by predicting one or more meeting participants may be late or absent well in advance of a meeting, and, depending on the importance of the meeting and/or the potential missing participants, recommending rescheduling the meeting. Implementation of embodiments of the invention may take a variety of forms, and exemplary implementation details are discussed subsequently with reference to the Figures.

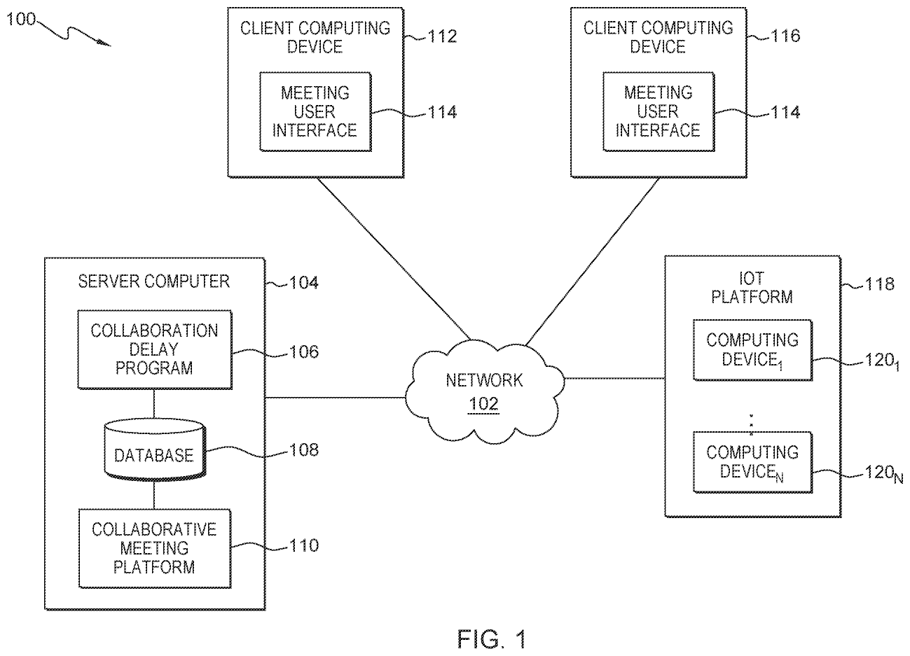

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, client computing device 112, client computing device 116, and Internet of Things (IoT) platform 118 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 112, client computing device 116, and IoT platform 118, and other computing devices (not shown) within distributed data processing environment 100.

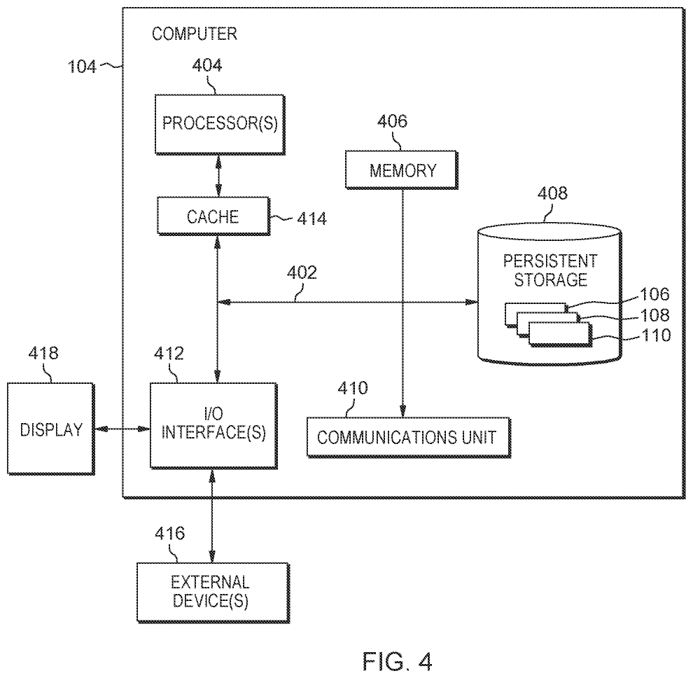

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 112, client computing device 116, IoT platform 118, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes collaboration delay program 106, database 108, and collaborative meeting platform 110. Server computer 104 may include internal and external hardware components, as depicted and described in further detail with respect to FIG. 4.

Collaboration delay program 106 is an IoT and artificial intelligence (AI) based system that can detect the start of a collaborative meeting, identify missing participants, predict the additional time that the missing participant will take to join the meeting as well as a reason why the participant is late, and notify the other meeting participants of the predicted time and reason the missing participant is late. Collaboration delay program 106 can also trigger well in advance of a collaborative meeting to determine the importance of the meeting, predict attendance, and, if the importance and/or predicted absences exceed a pre-defined threshold, determine a viable rescheduling of the meeting. Collaboration delay program 106 may be used by an enterprise or organization, or collaboration delay program 106 may be used by an individual. In the depicted embodiment, collaboration delay program 106 is a standalone program. In another embodiment, the function of collaboration delay program 106 is integrated into collaborative meeting platform 110.

In one embodiment, collaboration delay program 106 detects the start of a collaborative meeting and identifies the attendees. Collaboration delay program 106 determines the status of any missing participants. Collaboration delay program 106 predicts the duration and a reason for the delay of the missing participants. Collaboration delay program 106 confirms the prediction with the missing participants. Collaboration delay program 106 determines a reschedule recommendation for the meeting. Collaboration delay program 106 notifies the attendees of the meeting delay duration and reason and presents the reschedule recommendation to the attendees. Collaboration delay program 106 determines whether the recommendation is accepted. If the recommendation is not accepted, then collaboration delay program 106 determines the importance of the missing participants. If the importance exceeds a pre-defined threshold, then collaboration delay program 106 determines a second reschedule recommendation and notifies the important participant. If the second recommendation is not accepted, then collaboration delay program 106 receives an identified delegated participant. Collaboration delay program 106 reschedules the collaborative meeting and notifies the attendees and the missing participants of the reschedule.

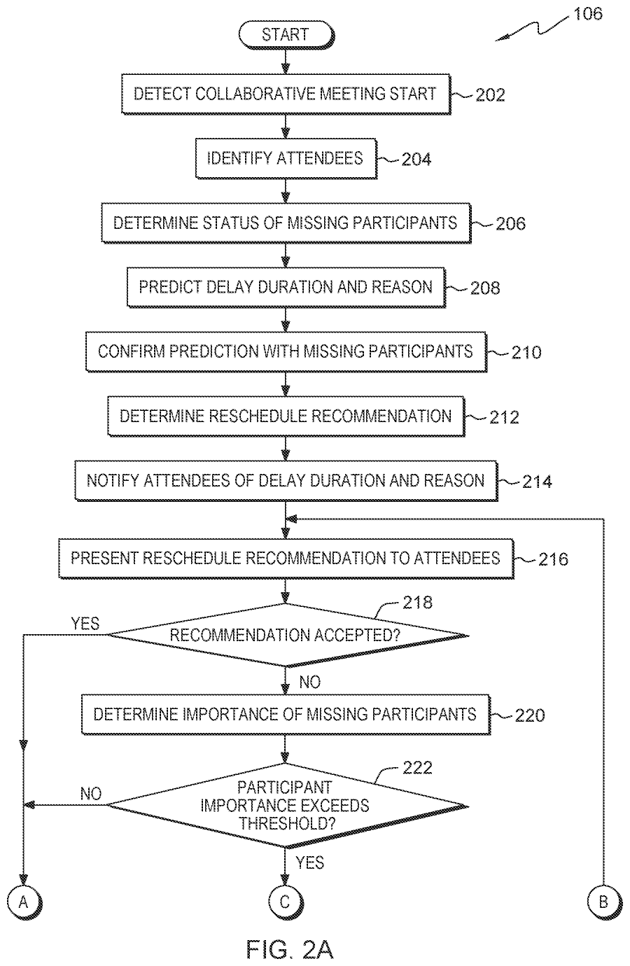

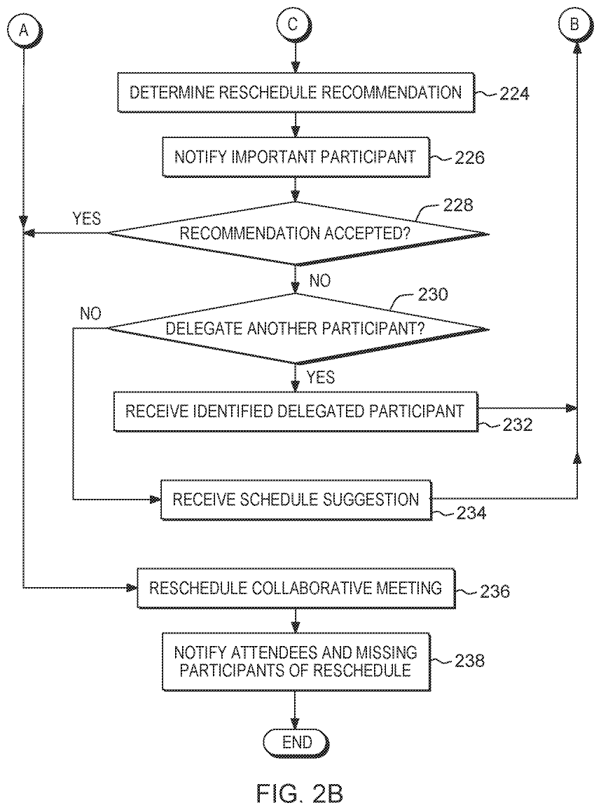

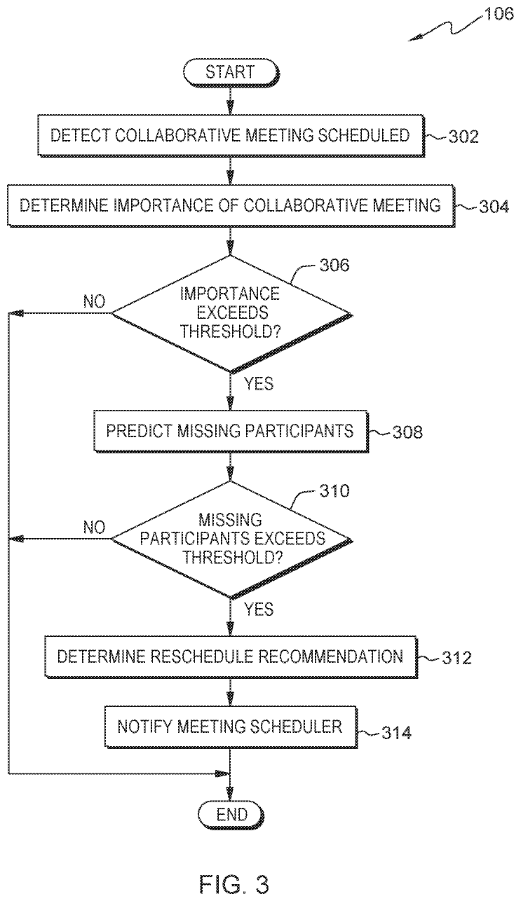

In another embodiment, collaboration delay program 106 detects that a collaborative meeting is scheduled. Collaboration delay program 106 determines the importance of the meeting, and, if the importance of the meeting exceeds a pre-defined threshold, then collaboration delay program 106 predicts which participants, i.e., invitees, will miss, or be late to, the meeting. If the number of missing participants exceeds a pre-defined threshold, then collaboration delay program 106 determines a reschedule recommendation and notifies the scheduler of the meeting. Collaboration delay program 106 is depicted and described in further detail with respect to FIGS. 2A, 2B, and 3.

Database 108 stores information used and generated by collaboration delay program 106. In the depicted embodiment, database 108 resides on server computer 104. In another embodiment, database 108 may reside elsewhere within distributed data processing environment 100, provided that collaboration delay program 106 has access to database 108. A database is an organized collection of data. Database 108 can be implemented with any type of storage device capable of storing data and configuration files that can be accessed and utilized by collaboration delay program 106, such as a database server, a hard disk drive, or a flash memory. Database 108 represents one or more databases that store a knowledge corpus associated with meeting predictions. For example, database 108 may store derived patterns of users' actions and/or movements. In another example, database 108 may store feedback from predictions. Database 108 also stores user profiles submitted by meeting participants, such as the user of client computing device 112 and the user of client computing device 116, via meeting user interface 114. The user profiles may include, but are not limited to, the name of the user, an address, an email address, a voice sample, a phone number, a credit card number, an account number, an employer, a job role, a job family, a business unit association, a job seniority, a job level, a resume, a medical record, a social network affiliation, etc. The user profile may also include user preferences, such as defaults for collaborative meeting platform 110, for example, whether to initially mute the microphone associated with client computing device 112 or whether to initially keep a camera associated with client computing device 112 turned off. User preferences may also include preferences for notifications coming from collaboration delay program 106, such as circumstances for notifications to be via text versus voice. In addition, database 108 may store a company directory that lists, for example, employees, job titles, and office locations. Further, database 108 may store one or more pre-defined thresholds for meeting predictions, such as a participant importance threshold, a meeting importance threshold, and a missing participants threshold.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Collaboration delay program 106 enables the authorized and secure processing of personal data. Collaboration delay program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Collaboration delay program 106 provides information regarding personal data and the nature (e.g., type, scope, purpose, duration, etc.) of the processing. Collaboration delay program 106 provides the user with copies of stored personal data. Collaboration delay program 106 allows the correction or completion of incorrect or incomplete personal data. Collaboration delay program 106 allows the immediate deletion of personal data.

Collaborative meeting platform 110 is one of a plurality of available software packages or online services with which users can hold live meetings, conferencing, presentations, and training via the Internet, particularly on TCP/IP connections. Collaborative meeting platform 110 may also be known as online meeting software or, sometimes, simply video conferencing. Collaborative meeting platform 110 enables remote meetings based on Voice over Internet Protocol (VoIP), online video, instant messaging, file sharing, and screen sharing.

Client computing device 112 and client computing device 116 can each be one or more of a laptop computer, a tablet computer, a smart phone, smart watch, a smart speaker, or any programmable electronic device capable of communicating with various components and devices within distributed data processing environment 100, via network 102. Client computing device 112 and client computing device 116 may each be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In an embodiment, the wearable computer may be in the form of a smart watch. In one embodiment, the wearable computer may be in the form of a head mounted display. The head mounted display may take the form-factor of a pair of glasses, such as augmented reality (AR) glasses. In an embodiment, client computing device 112 and client computing device 116 may each be integrated into a vehicle of the user. For example, client computing device 112 and client computing device 116 may each include a heads-up display in the windshield of the vehicle. In general, client computing device 112 and client computing device 116 each represents one or more programmable electronic devices or combination of programmable electronic devices capable of executing machine readable program instructions and communicating with other computing devices (not shown) within distributed data processing environment 100 via a network, such as network 102. Client computing device 112 and client computing device 116 each include an instance of meeting user interface 114.

Meeting user interface 114 provides an interface between collaborative meeting platform 110 on server computer 104 and a user of client computing device 112 and/or a user of client computing device 116. In one embodiment, meeting user interface 114 is mobile application software. Mobile application software, or an “app,” is a computer program designed to run on smart phones, tablet computers and other mobile devices. In one embodiment, meeting user interface 114 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. Meeting user interface 114 enables a user of client computing device 112 and/or a user of client computing device 116 to participate in meetings held using collaborative meeting platform 110. Meeting user interface 114 enables a user of client computing device 112 and/or a user of client computing device 116 to complete a user profile and store the profile in database 108. Collaboration delay program 106 interacts with and uses meeting user interface 114 to assist participants in a collaborative meeting by providing notifications and receiving responses.

IoT platform 118 is a suite of components that enable a) deployment of applications that monitor, manage, and control connected devices and sensors; b) remote data collection from connected devices; and c) independent and secure connectivity between devices. The components may include, but are not limited to, a hardware architecture, an operating system, and/or a runtime library (not shown). In the depicted embodiment, IoT platform 118 includes computing device 120_{1-N}. In another embodiment, IoT platform 118 may include a plurality of other connected sensors and computing devices.

Computing device 120_{1-N}, hereinafter computing device(s) 120, are a plurality of smart devices that can receive and act upon commands issued by the user of client computing device 112 and/or client computing device 116 via meeting user interface 114. As used herein, N represents a positive integer, and accordingly the number of scenarios implemented in a given embodiment of the present invention is not limited to those depicted in FIG. 1. For example, computing device(s) 120 may include security devices, such as alarms, smoke detectors, and video doorbells. In another example, computing device(s) 120 may include a climate control system, various appliances, and electronic devices. In yet another example, computing device(s) 120 may include a virtual assistant. In a further example, computing device(s) 120 may be one or more of a plurality of devices included in a smart/IoT enabled office, such as a smart air conditioner, a smart air quality sensor, a smart appliance, a smart humidifier, a motion sensor, an internet protocol (IP) camera, or a door sensor. In an embodiment, computing device(s) 120 include one or more sensors. In an embodiment, one or more devices included in IoT platform 118 may include a machine learning component that can learn a user's preferences over time by observing the user's actions. For example, an intelligent home climate control system may detect a pattern such as the user setting a thermostat for 65 degrees Fahrenheit in the mornings on Monday through Friday, when the user is not at home, and adjusting the thermostat to 70 degrees Fahrenheit for the rest of the time. Based on this pattern, the IoT device can set the thermostat without user intervention.

FIGS. 2A and 2B are a flowchart depicting operational steps of collaboration delay program 106, on server computer 104 within distributed data processing environment 100 of FIG. 1, for managing a collaboration delay, in accordance with an embodiment of the present invention.

Collaboration delay program 106 detects a collaborative meeting start (step 202). In an embodiment, when a user of client computing device 112 or client computing device 116 initiates a web conference meeting on collaborative meeting platform 110, via meeting user interface 114, collaboration delay program 106 detects the meeting initiation. In one embodiment, collaboration delay program 106 may detect a meeting participant clicking on a link in meeting user interface 114 to initiate the collaborative meeting. In another embodiment, collaboration delay program 106 may detect a participant or host sending a meeting notice, through collaborative meeting platform 110, an email application (not shown), or a calendaring application (not shown). In another embodiment, collaboration delay program 106 detects a collaborative meeting start when a participant uploads a meeting agenda to collaborative meeting platform 110. In an embodiment where an enterprise uses more than one collaborative meeting platform 110, a single sign-on can be used by the participants, such that the user enters authentication information once, and that authentication login then extends across multiple applications without the user having to login to each individual application.

In a further embodiment, collaboration delay program 106 detects a collaborative meeting start when two or more participants enter a physical conference room and collaboration delay program 106 detects the presence of the participants by receiving data from one or more computing device(s) 120. For example, if computing device 1201 is a conference room camera, then collaboration delay program 106 receives an image of two or more participants entering the conference room. In yet another embodiment, collaboration delay program 106 detects a collaborative meeting start when two or more participants call in by phone to a conference call number.

Collaboration delay program 106 identifies the attendees (step 204). In an embodiment, collaboration delay program 106 identifies the attendees, i.e., the users in attendance of the meeting, by detecting the users' identifications from their logging in to collaborative meeting platform 110. In another embodiment, collaboration delay program 106 identifies the attendees based on the location of client computing device 112 and/or client computing device 116 and corroboration with a meeting notice on the calendar of the user. For example, collaboration delay program 106 may use a global positioning system (GPS) associated with client computing device 112 to determine the location of the user of client computing device 112 is in a conference room listed in a meeting notice for the current time and date. In an embodiment, collaboration delay program 106 uses one or more natural language processing (NLP) techniques to determine details of the meeting location from the user's calendar or email. In yet another embodiment, collaboration delay program 106 identifies attendees using visual monitoring of one or more smart locations (e.g., offices, conference rooms) with one or more of computing device(s) 120. For example, using stored images of the users, collaboration delay program 106 can apply K-means clustering to the images of participants in a conference room to detect and identify each attendee. In a further example, because a location can have multiple attendees, collaboration delay program 106 may use Region Based Convolutional Neural Networks (R-CNN) based attendee detection in addition to the K-means clustering technique.

Collaboration delay program 106 determines the status of any missing participants (step 206). In an embodiment, by determining the attendees of the collaborative meeting in the previous step, collaboration delay program 106 also determines any missing participants. In an embodiment, collaboration delay program 106 determines the status of a missing participant based on the calendar of the missing participant. For example, collaboration delay program 106 may determine that the missing participant had an appointment scheduled for the hour prior to the collaborative meeting. In another embodiment, collaboration delay program 106 determines the status of a missing participant based on the location of the missing participant. For example, collaboration delay program 106 determines the missing participant is in a different conference room than the one designated for the collaborative meeting. In a further embodiment, collaboration delay program 106 determines the status of a missing participant based on communications by the missing participant, such as emails and text messages. For example, collaboration delay program 106 may determine the missing participant sent a text that says, “My current meeting is running long.” In an embodiment, collaboration delay program 106 uses one or more NLP techniques, such as syntax and semantics techniques, to understand unstructured data such as a calendar entry or communications.

Collaboration delay program 106 predicts the duration and reason for the delay (step 208). In an embodiment, collaboration delay program 106 uses machine learning to predict the duration of the delay of each missing participant as well as the reason for the delay. Collaboration delay program 106 performs unsupervised learning around the activities of the missing participants. For example, collaboration delay program 106 may detect driving patterns, i.e., predicting how much time it takes the user to drive from location A to location B. In another example, collaboration delay program 106 may detect a login pattern on a location change, i.e., predicting the earliest login time after the user arrives at home. In yet another example, collaboration delay program 106 may detect a moving pattern, i.e., predicting how much time it takes for the user to enter their home after parking the car. In a further example, collaboration delay program 106 may detect a collaboration pattern, i.e., considering the tone and/or emotion of an ongoing discussion, predicting the minimum amount of time for the discussion to conclude. In another example, collaboration delay program 106 may learn that if a user starts writing with a marker on a white board, then it will take at least ten minutes to finish the discussion.

In an embodiment, collaboration delay program 106 predicts the duration and reason for the delay based on various collaboration platforms and data. For example, based on the calendar of the missing participant, collaboration delay program 106 can determine the missing participant is in a meeting in an adjacent office building, and it will take the missing participant five minutes to arrive in the conference room of the collaborative meeting. In another example, based on the location of the missing participant, collaboration delay program 106 can determine the missing participant is driving home and will not login to the collaborative meeting for at least twenty minutes. In yet another example, based on a communication through a chat platform, text, or email from the missing participant, collaboration delay program 106 can determine that the missing participant has to complete a task in the next half hour before the missing participant can join the collaborative meeting. In a further example, based on the missing participant being logged in to another meeting, collaboration delay program 106 can determine the missing participant will be available in fifteen minutes. In another example, based on a system setting, such as the missing participant “snoozing” a calendar alarm for ten minutes, collaboration delay program 106 can determine the missing participant plans to join the collaborative meeting in ten minutes.

Collaboration delay program 106 confirms the prediction with the missing participants (step 210). In an embodiment, collaboration delay program 106 contacts the missing participant to confirm the prediction of the duration and reason for the delay. For example, if collaboration delay program 106 determined the missing participant is driving toward home, then collaboration delay program 106 may prompt the missing participant via a smart phone call, and ask, “Can you please confirm that you will be available for the collaborative meeting in fifteen minutes?” When collaboration delay program 106 receives a positive reply, then collaboration delay program 106 confirms the prediction. In an embodiment, in response to receiving confirmation of the prediction, collaboration delay program 106 stores the prediction and associated data in database 108 to add to the knowledge corpus as reinforcement learning.

Collaboration delay program 106 determines a reschedule recommendation (step 212). In an embodiment, based on the predicted delay duration and/or the reason for the delay, collaboration delay program 106 determines a recommendation for rescheduling the collaborative meeting. For example, based on the predicted delay of fifteen minutes until the missing participant is available for the meeting, collaboration delay program 106 determines a reschedule recommendation for fifteen minutes later than the original starting time. In an embodiment, in addition to the predicted delay duration, collaboration delay program 106 also considers the calendars/schedules of the attendees to determine the reschedule recommendation. For example, if collaboration delay program 106 determines one of the attendees has a conflict in a half hour, then collaboration delay program 106 determines a reschedule recommendation for later in the day, when all, or most, invitees are available.

Collaboration delay program 106 notifies the attendees of the duration and reason for the meeting delay (step 214). In an embodiment, collaboration delay program 106 notifies the attendees of the collaborative meeting of the predicted delay duration and reason for the missing participants. In an embodiment, collaboration delay program 106 notifies the attendees via meeting user interface 114. For example, collaboration delay program 106 may display a message in collaborative meeting platform 110 that states, “Participant X is in another meeting that is expected to conclude in ten minutes.” In another embodiment, collaboration delay program 106 may use one or more other notification techniques, including, but not limited to, text, voice, sound, video, or other visual indicator, depending on the location and/or other circumstances of the attendees. In an embodiment, collaboration delay program 106 also sends a notification to the missing participants.

Collaboration delay program 106 presents the reschedule recommendation to the attendees (step 216). In an embodiment, collaboration delay program 106 includes the determined reschedule recommendation in the notification to the attendees discussed in the previous step. In another embodiment, collaboration delay program 106 presents the reschedule recommendation to the attendees by sending a separate notification.

Collaboration delay program 106 determines whether the recommendation is accepted (decision block 218). In an embodiment, the reschedule recommendation notification includes an interactive element that enables the attendees to respond to the recommendation. For example, if collaboration delay program 106 presents the recommendation via meeting user interface 114, then the message can include check boxes that the attendees can click on to indicate whether they agree with the recommendation. In another example, if the attendees are in a smart conference room equipped with audio speakers, then collaboration delay program 106 can present the recommendation via spoken word and determine a spoken reply from one or more of the attendees.

In an example of the usage of collaboration delay program 106, worker A, worker B, and worker C work together in a smart, IoT-enabled office. Worker A has scheduled a meeting with worker B and worker C at 3:00 pm for half an hour. Worker A initiates the meeting on collaborative meeting platform 110 at 3:00 μm, and worker B joins the meeting. Collaboration delay program 106 detects the start of the meeting and the absence of worker C. Collaboration delay program 106 determines that worker C is in a conference room and in a discussion with worker D. Based on the status of the discussion, which collaboration delay program 106 derives from either the meeting platform or other indication from computing device(s) 120, collaboration delay program 106 predicts that the discussion between worker C and worker D will end in ten minutes. Collaboration delay program 106, using one or more of computing device(s) 120 in the conference room, such as a smart assistant, speaks to worker C, saying “Worker C and worker D, I am sorry to disturb you, but, referring to the meeting scheduled now for worker C, may I inform other attendees that worker C will be late by at least ten minutes?” Worker C responds “yes,” and collaboration delay program 106 receives the response. At 3:01 pm, collaboration delay program 106 displays a notification to worker A and worker B, via meeting user interface 114, that states, “Worker C has confirmed that he will be late by at least ten minutes. With that, and referring to the calendars of all three of you, would you like to reschedule the meeting to start at 3:15 pm?” Collaboration delay program 106 receives an acceptance to the reschedule recommendation from both worker A and worker B. Collaboration delay program 106 reschedules the meeting. Collaboration delay program 106 announces in the conference room, via one of computing device(s) 120, “Worker C and worker D, I am sorry to disturb you again. This is to inform you that the meeting has been rescheduled to start at 3:15 pm.”

In another example of the usage of collaboration delay program 106, worker A, worker B, and worker C work together in a smart, IoT-enabled office. Worker A has scheduled a meeting with worker B and worker C at 3:00 pm for half an hour. Worker B and worker C join the meeting on collaborative meeting platform 110 at 3:00 μm and are waiting for worker A to open the meeting. Collaboration delay program 106 detects the start of the meeting and the absence of worker A. Collaboration delay program 106 determines that worker A is driving from his office to his home. Collaboration delay program 106 has learned, based on preferences in the user profile of worker A, stored in database 108, that worker A prefers not to attend meetings while he is driving. Based on learned driving patterns, parking patterns, and walking patterns of worker A, collaboration delay program 106 predicts it will take worker A at least ten minutes to arrive home and login to collaborative meeting platform 110. Collaboration delay program 106 displays a notification to worker B and worker C, via meeting user interface 114, that states, “Worker A will be late by at least ten minutes. With that, and referring to the calendars of all three of you, would you like to continue or rejoin the meeting at 3:15 pm?” Collaboration delay program 106 receives an acceptance to the reschedule recommendation from both worker B and worker C. Collaboration delay program 106 announces in the car, via one of computing device(s) 120, “Worker A, I am sorry to disturb you, but this is just to inform you that, because you are running late, the meeting at 3:00 pm will now start at 3:15 pm.” Collaboration delay program 106 receives confirmation from worker A when worker A says, “Thanks.” Collaboration delay program 106 stores the feedback in database 108 to add to the knowledge corpus as reinforcement learning.

If collaboration delay program 106 determines the recommendation is not accepted (“no” branch, decision block 218), then collaboration delay program 106 determines the importance of the missing participants (step 220). In an embodiment, collaboration delay program 106 determines the importance of the missing participants to the quality or outcome of the meeting in order to determine whether or not to prioritize that participant's schedule in the reschedule recommendation. In an embodiment, collaboration delay program 106 derives the importance of a missing participant based on one or more weighted components. For example, weighted components may include, but are not limited to, the participant's role/designation, whether the participant is a subject matter decision making authority, whether the participant is an equivalent stake holder of the same role/designation that is available for decision making, and skills, such as subject matter expert (SME). In an embodiment, collaboration delay program 106 sums the weighted components to determine an importance index score of a missing participant.

Collaboration delay program 106 determines whether the importance of the missing participants exceeds a pre-defined threshold (decision block 222). In an embodiment, collaboration delay program 106 compares the importance of the missing participant to a pre-defined threshold importance score to determine whether the importance exceeds the threshold. For example, if the threshold importance score is 60 percent and collaboration delay program 106 determines the importance of the missing participant is 72 percent, then collaboration delay program 106 determines that the importance of the missing participant exceeds the pre-defined threshold.

If collaboration delay program 106 determines the importance of the missing participants exceeds a pre-defined threshold (“yes” branch, decision block 222), then collaboration delay program 106 determines a second reschedule recommendation (step 224). In an embodiment, collaboration delay program 106 consults the calendar of the important participant as a priority when determining a second reschedule recommendation. In an embodiment where collaboration delay program 106 determines more than one missing participant is an important participant, i.e., the associated importance exceeds the pre-defined threshold, then collaboration delay program 106 determines a second reschedule recommendation by prioritizing schedules based on the importance score of each important participant. In an embodiment, collaboration delay program 106 excludes the previously generated recommendation which is not acceptable to important participant.

Collaboration delay program 106 notifies the important participant (step 226). In an embodiment, collaboration delay program 106 sends a notification to the important participant that includes the second reschedule recommendation and explains that the second recommendation is made in deference to the schedule of the important person. The notification may also state the importance of the participant to the context of the discussion and for decision making on the topic, based on the weighted components included in the importance score.

Collaboration delay program 106 determines whether the second recommendation is accepted (decision block 228). In an embodiment, as was discussed with respect to decision block 218, the second reschedule recommendation notification includes an interactive element that enables the important participant to respond to the recommendation.

If collaboration delay program 106 determines the second recommendation is not accepted (“no” branch, decision block 228), then collaboration delay program 106 determines whether the important participant wants to delegate to another participant (decision block 230). In an embodiment, collaboration delay program 106 gives the important participant an option to delegate attendance and/or responsibility of the important participant for the meeting to another participant. For example, collaboration delay program 106 may send a notification to the important participant that asks, “Would you like to delegate responsibility for this meeting to another participant?” In another example, collaboration delay program 106 may include the question in the notification discussed with respect to step 226.

If collaboration delay program 106 determines the important participant wants to delegate to another participant (“yes” branch, decision block 230), then collaboration delay program 106 receives an identified delegated participant (step 232). In an embodiment, when the important participant responds to the notification regarding delegating another participant, collaboration delay program 106 receives the identified delegated participant. Responsive to receiving an identified delegated participant, collaboration delay program 106 returns to step 216 to present the reschedule recommendation to the attendees and to the identified delegated participant if the identified delegated participant is not already one of the attendees.

If collaboration delay program 106 determines the important participant does not want to delegate to another participant (“no” branch, decision block 230), then collaboration delay program 106 receives a schedule suggestion (step 234). In an embodiment, when the important participant responds to the notification regarding not delegating another participant, collaboration delay program 106 receives a suggestion for re-scheduling the meeting from the important participant for the collaborative meeting which the important participant is able to attend. In an embodiment, collaboration delay program 106 may combine the request for acceptance of the reschedule recommendation and a delegated participant into one notification. For example, at step 226, collaboration delay program 106 may provide a notification to the important participant that states, “Your attendance at this meeting is important because of a decision that has to be made. I recommend rescheduling the meeting to 4:00 pm. Do you accept the recommendation, or would you prefer to delegate the decision making to another participant?”

Responsive to receiving the schedule suggestion, collaboration delay program 106 returns to step 216 to present the reschedule recommendation to the attendees.

If collaboration delay program 106 determines the first schedule recommendation is accepted (“yes” branch, decision block 218), or if collaboration delay program 106 determines the importance of the missing participants does not exceed a pre-defined threshold (“no” branch, decision block 222), or if collaboration delay program 106 determines the second schedule recommendation is accepted (“yes” branch, decision block 228), then collaboration delay program 106 reschedules the collaborative meeting (step 236). In an embodiment, based on the availability of the attendees and the missing participants, collaboration delay program 106 reschedules the collaborative meeting to either a previously recommended time or a time of a received suggestion.

Collaboration delay program 106 notifies the attendees and the missing participants of the reschedule (step 238). In an embodiment, collaboration delay program 106 sends a notification to the attendees and the missing participants that indicates the reschedule of the collaborative meeting. In an embodiment, collaboration delay program 106 notifies the attendees and missing participants via meeting user interface 114. In another embodiment, collaboration delay program 106 may use one or more other notification techniques, as discussed with respect to step 214.

FIG. 3 is a flowchart depicting operational steps of collaboration delay program 106, on server computer 104 within distributed data processing environment 100 of FIG. 1, for predicting a collaboration delay, in accordance with an embodiment of the present invention.

Collaboration delay program 106 detects that a collaborative meeting is scheduled (step 302). In an embodiment, collaboration delay program 106 continuously monitors one or more communications applications to detect when a user, i.e., a meeting scheduler, schedules a meeting. For example, collaboration delay program 106 may detect a meeting is scheduled when a user sends a meeting notice via a calendar application. In another example, collaboration delay program 106 may detect a meeting is scheduled when a user sets up a meeting in collaborative meeting platform 110 via meeting user interface 114.

Collaboration delay program 106 determines the importance of the collaborative meeting (step 304). In an embodiment, collaboration delay program 106 determines the importance of the scheduled collaborative meeting based on one or more indicators or flags in the meeting notice. For example, indicators or flags may include, but are not limited to, the subject of the meeting, the agenda of the meeting, text that includes terms that indicate importance, such as “urgent,” text in a bold font, text that includes an “act by” date, a job role of one or more invitees, etc. In an embodiment, based on the detected indicators, collaboration delay program 106 assigns an importance score to the meeting.

Collaboration delay program 106 determines whether the importance of the meeting exceeds a pre-defined threshold (decision block 306). In an embodiment, a system administrator defines an importance score threshold. In another embodiment, a user of collaboration delay program 106 defines an importance score threshold and includes the threshold as a preference in the user's profile stored in database 108.

If collaboration delay program 106 determines the importance of the meeting exceeds a pre-defined threshold (“yes” branch, decision block 306), then collaboration delay program 106 predicts missing participants (step 308). In an embodiment, collaboration delay program 106 reviews calendars, schedules, communications, etc., of each of the invitees in the scheduled meeting notice to determine any conflicts that may result in the invitee being late or absent to the scheduled meeting. Based on the review, collaboration delay program 106 predicts if one or more of the invitees will be a missing participant. In an embodiment, collaboration delay program 106 also uses learning associated with various patterns of each of the invitees, as discussed with respect to step 208 of FIG. 2, to determine which invitees will be missing participants.

Collaboration delay program 106 determines whether the number of missing participants exceeds a pre-defined threshold (decision block 310). In an embodiment, a system administrator defines a missing participants threshold. In another embodiment, a user of collaboration delay program 106 defines missing participants threshold and includes the threshold as a preference in the user's profile stored in database 108. For example, the threshold may be a percentage of the invitees, such as 55 percent, or a number of invitees. In an embodiment, more than one missing participant threshold is defined, based on the number of invitees. For example, if the number of invitees is greater than 75, then the threshold is 40 percent, but if the number of invitees is less than ten, then the threshold is two invitees.

If collaboration delay program 106 determines the number of missing participants exceeds a pre-defined threshold (“yes” branch, decision block 310), then collaboration delay program 106 determines a reschedule recommendation (step 312). In an embodiment, collaboration delay program 106 considers the calendars/schedules of the invitees to determine a reschedule recommendation. For example, if collaboration delay program 106 determines, based on the meeting notice, that it is important to the team manager, who scheduled the meeting, that the majority of the team is present for an important announcement, then collaboration delay program 106 reviews the calendars, schedules, and/or learned patterns associated with each of the team members to predict a date and time when the number of missing participants is likely to not exceed the missing participants threshold.

Collaboration delay program 106 notifies the meeting scheduler (step 314). In an embodiment, collaboration delay program 106 sends a notification to the user that scheduled the meeting to indicate the reschedule recommendation. In an embodiment, collaboration delay program 106 notifies the meeting scheduler via meeting user interface 114. For example, collaboration delay program 106 may display a message in collaborative meeting platform 110 that states, “More than 50 percent of the invitees will likely be missing or late to the scheduled meeting. I recommend you reschedule for Tuesday at 4:00 pm.” In another embodiment, collaboration delay program 106 may use one or more other notification techniques, including, but not limited to, text, voice, sound, video, or other visual indicator, depending on the location and/or other circumstances of the meeting scheduler.

If collaboration delay program 106 determines the importance of the meeting does not exceed a pre-defined threshold (“no” branch, decision block 306), or if collaboration delay program 106 determines the number of missing participants does not exceed a pre-defined threshold (“no” branch, decision block 310), then collaboration delay program 106 ends execution, and the scheduled collaborative meeting remains unchanged.

FIG. 4 depicts a block diagram of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., collaboration delay program 106, database 108, and collaborative meeting platform 110, are stored in persistent storage 408 for execution and/or access by one or more of the respective processor(s) 404 of server computer 104 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 112, client computing device 116, and IoT platform 118. In these examples, communications unit 410 includes one or more network interface cards. Communications unit 410 may provide communications through the use of either or both physical and wireless communications links. Collaboration delay program 106, database 108, collaborative meeting platform 110, and other programs and data used for implementation of the present invention, may be downloaded to persistent storage 408 of server computer 104 through communications unit 410.

I/O interface(s) 412 allows for input and output of data with other devices that may be connected to server computer 104. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., collaboration delay program 106, database 108, and collaborative meeting platform 110 on server computer 104, can be stored on such portable computer readable storage media and can be loaded onto persistent storage 408 via I/O interface(s) 412. I/O interface(s) 412 also connect to display 418.

Display 418 provides a mechanism to display data to a user and may be, for example, a computer monitor. Display 418 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
detecting, by one or more computer processors, a start of a first collaborative meeting;
identifying, by one or more computer processors, one or more attendees of the first collaborative meeting;
determining, by one or more computer processors, a status of one or more missing participants;
based on the status, predicting, by one or more computer processors, a delay duration and a reason for a delay of at least one of the one or more missing participants;
based on the prediction, determining, by one or more computer processors, a first reschedule recommendation for the first collaborative meeting;
presenting, by one or more computer processors, the first reschedule recommendation to the one or more attendees;
rescheduling, by one or more computer processors, the first collaborative meeting; and
notifying, by one or more computer processors, the one or more attendees of the first collaborative meeting of the reschedule.

2. The computer-implemented method of claim 1, further comprising:
determining, by one or more computer processors, the first reschedule recommendation was not accepted;
determining, by one or more computer processors, an importance of at least one of the one or more missing participants to the first collaborative meeting;
determining, by one or more computer processors, the importance of the at least one of the one or more missing participants exceeds a pre-defined threshold, wherein the at least one of the one or more missing participants whose importance exceeds the pre-defined threshold is an important participant;
determining, by one or more computer processors, a second reschedule recommendation based on a schedule of the important participant;
notifying, by one or more computer processors, the important participant of the second reschedule recommendation; and
determining, by one or more computer processors, the second reschedule recommendation is accepted.

3. The computer-implemented method of claim 2, further comprising:
determining, by one or more computer processors, the second reschedule recommendation is not accepted;
determining, by one or more computer processors, the important participant will delegate responsibility to another participant; and
receiving, by one or more computer processors, an identified delegated participant.

4. The computer-implemented method of claim 2, wherein determining the importance of the at least one of the one or more missing participants further comprises:
deriving, by one or more computer processors, an importance score based on one or more weighted components, wherein the weighted components include at least one of: a role of the participant, a designation of the participant, whether the participant is a subject matter decision making authority, whether the participant is a subject matter expert (SME), and one or more skills of the participant.

5. The computer-implemented method of claim 1, wherein the prediction of the delay duration and the reason for the delay of at least one of the one or more missing participants is based on at least one of: a calendar of the missing participant, a location of the missing participant, a communication from the missing participant, the missing participant being logged in to another meeting, and a system setting.

6. The computer-implemented method of claim 1, wherein predicting the delay duration and the reason for the delay of at least one of the one or more missing participants further comprises:
performing, by one or more computer processors, unsupervised learning around one or more activities of the one or more missing participants; and
detecting, by one or more computer processors, one or more patterns associated with the one or more activities, wherein the one or more patterns include at least one of: a driving pattern, a login pattern on a location change, a moving pattern, and a collaboration pattern.

7. The computer-implemented method of claim 1, further comprising:
detecting, by one or more computer processors, a second collaborative meeting is scheduled by a meeting scheduler;
determining, by one or more computer processors, an importance of the second collaborative meeting;
determining, by one or more computer processors, the importance of the second collaborative meeting exceeds a pre-defined importance threshold;
predicting, by one or more computer processors, one or more participants that will miss the second collaborative meeting;
determining, by one or more computer processors, a number of the one or more participants that will miss the second collaborative meeting exceeds a pre-defined missing participants threshold;
determining, by one or more computer processors, a third reschedule recommendation; and
notifying, by one or more computer processors, the meeting scheduler of the third reschedule recommendation.

8. The computer-implemented method of claim 7, wherein the importance of the second collaborative meeting is based on one or more indicators in an associated meeting notice, and wherein the one or more indicators include at least one of: a subject of the meeting notice, an agenda of the meeting notice, text in the meeting notice that includes terms that indicate importance, text in the meeting notice in a bold font, text in the meeting notice that includes an “act by” date, and a job role of one or more invitees.

9. A computer program product comprising:
one or more computer readable storage media and program instructions collectively stored on the one or more computer readable storage media, the stored program instructions comprising:
program instructions to detect a start of a first collaborative meeting;
program instructions to identify one or more attendees of the first collaborative meeting;
program instructions to determine a status of one or more missing participants;
based on the status, program instructions to predict a delay duration and a reason for a delay of at least one of the one or more missing participants;
based on the prediction, program instructions to determine a first reschedule recommendation for the first collaborative meeting;
program instructions to present the first reschedule recommendation to the one or more attendees;
program instructions to reschedule the first collaborative meeting; and
program instructions to notify the one or more attendees of the first collaborative meeting of the reschedule.

10. The computer program product of claim 9, the stored program instructions further comprising:
program instructions to determine the first reschedule recommendation was not accepted;
program instructions to determine an importance of at least one of the one or more missing participants to the first collaborative meeting;
program instructions to determine the importance of the at least one of the one or more missing participants exceeds a pre-defined threshold, wherein the at least one of the one or more missing participants whose importance exceeds the pre-defined threshold is an important participant;
program instructions to determine a second reschedule recommendation based on a schedule of the important participant;
program instructions to notify the important participant of the second reschedule recommendation; and
program instructions to determine the second reschedule recommendation is accepted.

11. The computer program product of claim 10, the stored program instructions further comprising:
program instructions to determine the second reschedule recommendation is not accepted;
program instructions to determine the important participant will delegate responsibility to another participant; and
program instructions to receive an identified delegated participant.

12. The computer program product of claim 10, wherein the program instructions to determine the importance of the at least one of the one or more missing participants comprise:
program instructions to derive an importance score based on one or more weighted components, wherein the weighted components include at least one of: a role of the participant, a designation of the participant, whether the participant is a subject matter decision making authority, whether the participant is a subject matter expert (SME), and one or more skills of the participant.

13. The computer program product of claim 9, wherein the program instructions to predict the delay duration and the reason for the delay of at least one of the one or more missing participants comprise:
program instructions to perform unsupervised learning around one or more activities of the one or more missing participants; and
program instructions to detect one or more patterns associated with the one or more activities, wherein the one or more patterns include at least one of: a driving pattern, a login pattern on a location change, a moving pattern, and a collaboration pattern.

14. The computer program product of claim 9, the stored program instructions further comprising:
program instructions to detect a second collaborative meeting is scheduled by a meeting scheduler;
program instructions to determine an importance of the second collaborative meeting;
program instructions to determine the importance of the second collaborative meeting exceeds a pre-defined importance threshold;
program instructions to predict one or more participants that will miss the second collaborative meeting;
program instructions to determine a number of the one or more participants that will miss the second collaborative meeting exceeds a pre-defined missing participants threshold;
program instructions to determine a third reschedule recommendation; and
program instructions to notify the meeting scheduler of the third reschedule recommendation.

15. A computer system comprising:
one or more computer processors;
one or more computer readable storage media;
program instructions collectively stored on the one or more computer readable storage media for execution by at least one of the one or more computer processors, the stored program instructions comprising:
program instructions to detect a start of a first collaborative meeting;
program instructions to identify one or more attendees of the first collaborative meeting;
program instructions to determine a status of one or more missing participants;
based on the status, program instructions to predict a delay duration and a reason for a delay of at least one of the one or more missing participants;
based on the prediction, program instructions to determine a first reschedule recommendation for the first collaborative meeting;
program instructions to present the first reschedule recommendation to the one or more attendees;
program instructions to reschedule the first collaborative meeting; and
program instructions to notify the one or more attendees of the first collaborative meeting of the reschedule.

16. The computer system of claim 15, the stored program instructions further comprising:
program instructions to determine the first reschedule recommendation was not accepted;
program instructions to determine an importance of at least one of the one or more missing participants to the first collaborative meeting;
program instructions to determine the importance of the at least one of the one or more missing participants exceeds a pre-defined threshold, wherein the at least one of the one or more missing participants whose importance exceeds the pre-defined threshold is an important participant;
program instructions to determine a second reschedule recommendation based on a schedule of the important participant;
program instructions to notify the important participant of the second reschedule recommendation; and
program instructions to determine the second reschedule recommendation is accepted.

17. The computer system of claim 16, the stored program instructions further comprising:
program instructions to determine the second reschedule recommendation is not accepted;
program instructions to determine the important participant will delegate responsibility to another participant; and
program instructions to receive an identified delegated participant.

18. The computer system of claim 16, wherein the program instructions to determine the importance of the at least one of the one or more missing participants comprise:
program instructions to derive an importance score based on one or more weighted components, wherein the weighted components include at least one of: a role of the participant, a designation of the participant, whether the participant is a subject matter decision making authority, whether the participant is a subject matter expert (SME), and one or more skills of the participant.

19. The computer system of claim 15, wherein the program instructions to predict the delay duration and the reason for the delay of at least one of the one or more missing participants comprise:
program instructions to perform unsupervised learning around one or more activities of the one or more missing participants; and
program instructions to detect one or more patterns associated with the one or more activities, wherein the one or more patterns include at least one of: a driving pattern, a login pattern on a location change, a moving pattern, and a collaboration pattern.

20. The computer system of claim 15, the stored program instructions further comprising:
program instructions to detect a second collaborative meeting is scheduled by a meeting scheduler;
program instructions to determine an importance of the second collaborative meeting;
program instructions to determine the importance of the second collaborative meeting exceeds a pre-defined importance threshold;
program instructions to predict one or more participants that will miss the second collaborative meeting;
program instructions to determine a number of the one or more participants that will miss the second collaborative meeting exceeds a pre-defined missing participants threshold;
program instructions to determine a third reschedule recommendation; and
program instructions to notify the meeting scheduler of the third reschedule recommendation.
